(19) United States
(12) Patent Application Publication
(10) Pub. No.: US 2020/0364812 A1
(43) Pub. Date: Nov. 19, 2020

(54) METHOD AND SYSTEM FOR PROVIDING REAL ESTATE TRANSACTION SERVICE

(71) Applicants: Gee Woo SHIM, Seoul (KR); Sun Kyung PARK, Seoul (KR)

(72) Inventors: Gee Woo SHIM, Seoul (KR); Sun Kyung PARK, Seoul (KR)

(21) Appl. No.: 16/770,429

(22) PCT Filed: Dec. 8, 2017
(86) PCT No.: PCT/KR2017/014381

§ 371 Date: Jun. 5, 2020

(51) Int. Cl. G06Q 50/16; G06Q 20/36; G06Q 20/10

(52) U.S. Cl. CPC G06Q 50/167; G06Q 20/108; G06Q 20/3674

(57) ABSTRACT

A method and system for providing real estate transaction service by an escrow server in a real estate transaction service system including an escrow server, a bank server, and a transaction server, which includes: checking authentication of parties involved in a first transaction contract, and generating first transaction management integration data; converting transaction money transferred from the buyer into virtual money; checking authentication of parties involved in a second transaction contract, and generating second transaction management integration data; updating details of payment of the first transaction management integration data and money transfer of the second transaction management integration data; and transmitting a command to the bank server such that the entire amount of transferred money registered in the second transaction management integration data is paid in cash to the seller of the second transaction contract upon receiving a signal, indicating that the procedure of real estate-related registration is completed.

### TECHNICAL FIELD

The present invention relates to a method and system for providing a real estate transaction service and, more particularly, to a method and system for providing a real estate transaction service using an escrow method.

### BACKGROUND ART

In common real estate transactions, a method of making a trading contract related to a real property and writing up a contract related to the real property through a real estate office between a buyer and a seller and then exchanging a sale price and the real property through a broker is used. In this case, the sale price is commonly paid from the buyer to the seller in order of a down payment, a middle payment, and the remainder. When the seller that has received even the remainder performs transfer registration for the buyer, the real property is finally transferred to the buyer.

In such real estate transactions, however, there is always a possibility that property damage to the other party may occur due to the default of any one party of a buyer or a seller. In particular, upon real property sales, a case where associated real property sales contracts are simultaneously performed, such as that a seller sells his or her real property to a buyer and also buys another real property from a third party, frequently occurs. If the buyer does not pay a price to the seller at an agreed date, there is a possibility that the contracts may be broken one after another because the seller also does not pay a price to the third party.

In order to solve such a problem, a real estate transaction method using an escrow method in which a third institution holds a sale price in trust was developed, and a related technology includes Korean Patent Application Laid-Open No. 10-2007-0084745 (SERVICE METHOD OF ESCROW SERVER, ESCROW SYSTEM ANDESCROW SERVER FOR DEALING IN REAL ESTATE). The technology is characterized in that when the escrow server receives real estate sale transaction information from information input terminals used by a buyer and a seller and receives deposit information from a bank network, the escrow server transmits the deposit information to the information input terminal and transmits an automatic transfer order to a bank network. The technology may be effective in transactions between both persons directly involved, but has a limit to generally managing a plurality of associated trading contracts, such as a seller sells his or her real property to a buyer and simultaneously buys another real property from a third party, frequently occurs.

Furthermore, when a real property seller uses an escrow method, it is difficult for the real property seller to withdraw a down payment and a middle payment deposited by a buyer because the down payment and the middle payment are managed by an escrow institute. Accordingly, if a contract for purchasing another real property from a third party is performed at the same time, the real property seller cannot use a down payment and middle payment deposited by the buyer.

### DISCLOSURE

### Technical Problem

The present invention is for solving the above problems, and an object of the present invention is to provide a method and system for providing a real estate transaction service, wherein a plurality of associated real estate transaction contracts can be integrated and managed at the center so that the contracts can be safely performed.

Furthermore, another object of the present invention is to provide a method and system for providing a real estate transaction service, wherein when a real property seller simultaneously performs a contract for purchasing another real property from a third party, the real property seller can use a down payment and a middle payment deposited by a buyer.

### Technical Solution

A method of providing, by an escrow server, a real estate transaction service in a real estate transaction service system including the escrow server, a bank server and a transaction server includes the step of confirming the authentication of parties of a first trading contract when first trading contract information is received from the transaction server and then generating first transaction management integrated data, the step of converting, into cryptocurrency, a transaction price deposited by the buyer of the first trading contract, the step of confirming the authentication of parties of a second trading contract when second trading contract information including at least one of the parties of the first trading contract is received from the transaction server and then generating second transaction management integrated data, the step of updating payment details of the first transaction management integrated data and deposit details of the second transaction management integrated data when the seller or the first trading contract makes a cryptocurrency payment request, and the final payment step of transmitting, to the bank server, an order instructing a total deposit amount registered with the second transaction management integrated data to be paid to the seller or the second trading contract in cash when real estate-related report procedure completion signals related to the first trading contract and the second trading contract are received from the transaction server.

In the present invention, each of the first and second trading contract information may include at least one of an item address, a sales amount, a lease guarantee amount, a contract amount, a payment condition, a contract date, a middle payment date, a remainder date, buyer information, seller information, lessor information, and lessee information.

In the present invention, each of the first and second transaction management integrated data may include a present situation table and trading contract information including a down payment, a middle payment, a date for each remainder, a deposit amount, the amount of payment, a policy number and a payment place.

In the present invention, the step of converting the transaction price into the cryptocurrency may further include the step of writing the converted cryptocurrency in the deposit details of the first transaction management integrated data and generating a policy number.

In the present invention, the step of generating the second transaction management integrated data may include confirming the authentication of the parties of the first trading contract and the second trading contract when the second trading contract information is received and then generating the second transaction management integrated data.

In the present invention, the updating step may include the steps of writing the amount of money requested to be paid in the first transaction management integrated data as the payment details when the seller of the first trading contract makes the cryptocurrency payment request, generating a derivation number of the generated policy number as a policy number of the payment details and writing the generated derivation number in the first transaction management integrated data, writing a policy number of the second transaction management integrated data in a payment place of the first transaction management integrated data, writing an amount written in the payment details as the deposit details of the second transaction management integrated data, and identically writing, in the deposit details of the second transaction management integrated data, a policy number identical with the policy number written as the payment details in the first transaction management integrated data.

In the present invention, the final payment step may include the steps of settling the cryptocurrency managed in the first transaction management integrated data when the real estate-related report procedure completion signal related to the first trading contract is received from the transaction server, and transmitting, to the bank server, an order instructing the total deposit amount registered with the second transaction management integrated data to be paid to the seller of the second trading contract in cash when the real estate-related report procedure completion signal related to the second trading contract is received from the transaction server.

In the present invention, the settling step may include the steps of writing, in the payment details of the first transaction management integrated data, the amount of money to be paid for which the seller of the first trading contract has requested when the real estate-related report procedure completion signal related to the first trading contract is received from the transaction server, writing, in the first transaction management integrated data, a policy number, a payment place and a purchase amount payment completion message corresponding to the payment details, writing an amount identical with the amount, written in the first transaction management integrated data as the payment details, in the second transaction management integrated data as the deposit details, and identically writing, in the deposit details of the second transaction management integrated data, a policy number identical with the policy number written in the first transaction management integrated data.

The method of providing a real estate transaction service according to the present invention may further include the steps of comparing a total amount to be paid for which the seller of the first trading contract has requested with a total transaction price of the first trading contract and transmitting, to the bank server, an order instructing a difference to be paid to the seller of the first trading contract when the total transaction price of the first trading contract is greater than the total amount requested to be paid.

In the present invention, the step of transmitting the order to the bank server may include the steps of writing, as the payment details, a total deposit amount registered with the second transaction management integrated data when the real estate-related report procedure completion signal related to the second trading contract is received from the transaction server, writing a purchase amount payment completion message in the second transaction management integrated data, and transmitting, to the bank server, an order instructing the amount written as the payment details to be paid to the seller of the second trading contract in cash.

The method of providing a real estate transaction service according to the present invention may further include the steps of confirming the authentication of the parties of the first trading contract, the second trading contract and a third trading contract when third trading contract information including at least one of the parties of the first trading contract and the second trading contract is received from the transaction server and then generating third transaction management integrated data, updating the payment details of the first transaction management integrated data, the deposit details and payment details of the second transaction management integrated data, and deposit details of the third transaction management integrated data when the seller of the first trading contract makes the cryptocurrency payment request, and transmitting, to the bank server, an order instructing a total deposit amount registered with the third transaction management integrated data to be paid to the seller or the third trading contract in cash when real estate-related report procedure completion signals related to the first trading contract, the second trading contract and the third trading contract are received from the transaction server.

A system for providing a real estate transaction service according to an embodiment of the present invention includes a transaction server generating trading contract information and a real estate-related report procedure completion signal related to a trading contract, an escrow server confirming the authentication of parties of the first trading contract when first trading contract information is received from the transaction server and then generating first transaction management integrated data, converting, into cryptocurrency, a transaction price deposited by the buyer of the first trading contract, confirming the authentication of parties of the first trading contract and the second trading contract when second trading contract information including at least one of the parties of the first trading contract is received and then generating second transaction management integrated data, updating payment details of the first transaction management integrated data and deposit details of the second transaction management integrated data when the seller or the first trading contract makes a cryptocurrency payment request, and transmitting, to a bank server, an order instructing a total deposit amount registered with the second transaction management integrated data to be paid to the seller or the second trading contract when real estate-related report procedure completion signals related to the first trading contract and the second trading contract are received from the transaction server, and the bank server executing the payment of the cash to an agreed account registered with the seller of the second trading contract when the cash payment order is received from the escrow server.

An escrow server according to an embodiment of the present invention includes a trading contract information reception unit receiving, from a transaction server, first trading contract information and second trading contract information including at least one of parties of a first trading contract, a virtual account management unit confirming whether a transaction price has been deposited by the buyer of the first trading contract or a buyer of a second trading contract, a cryptocurrency conversion unit converting, into cryptocurrency, the transaction price deposited by the buyer of the first trading contract or the buyer of the second trading contract, and a transaction management integrated data management unit generating first transaction management integrated data after confirming the authentication of parties of the first trading contract, generating second transaction management integrated data after confirming the authentication of parties of the first trading contract and the second trading contract, updating payment details of the first transaction management integrated data and deposit details of the second transaction management integrated data when the seller or the first trading contract makes a cryptocurrency payment request, and transmitting, to a bank server, an order instructing a total deposit amount registered with the second transaction management integrated data to be paid to the seller or the second trading contract in cash when real estate-related report procedure completion signals related to the first trading contract and the second trading contract are received from the transaction server.

### Advantageous Effects

According to the present invention, when a seller performs a plurality of real estate transaction contracts for buying another real property from a third party while selling his or her real property, real estate transactions can be performed more safely because the contracts are integrated and managed in the escrow server.

Furthermore, when simultaneously performing a contract for purchasing another real property, a real property seller can reduce a burden of the payment of a price because the seller can use a down payment and middle payment deposited by a buyer.

### DESCRIPTION OF DRAWINGS

FIG. 1 shows a configuration of a system 10 for providing a real estate transaction service according to an embodiment of the present invention.

FIG. 2 is a diagram for describing elements within an escrow server 200 according to an embodiment of the present invention.

FIG. 3 is a flowchart illustrating a method of providing, by the escrow server 200, a real estate transaction service according to an embodiment of the present invention.

FIG. 4 is a flowchart illustrating detailed steps of step S311 in FIG. 3.

FIG. 5 is a flowchart illustrating detailed steps of step S314 in FIG. 3.

FIG. 6 is a flowchart illustrating detailed steps of step S316 in FIG. 3.

FIG. 7 is a diagram illustrating an example of transaction management integrated data in the method of providing a real estate transaction service in FIG. 3.

FIG. 8 is a flowchart illustrating a process of processing, by a tax server 500, tax-related business after real estate transactions are completed according to an embodiment of the present invention.

FIG. 9 is a flowchart for describing a process of updating, by the escrow server 200, first transaction management integrated data to third transaction management integrated data when three associated real estate transaction contracts are performed in the method of providing a real estate transaction service according to an embodiment of the present invention.

FIG. 10 is a diagram illustrating another example of transaction management integrated data in the method of providing a real estate transaction service in FIG. 9.

### BEST MODE FOR INVENTION

Embodiments of the present invention are described hereinafter in detail with reference to the accompanying drawings, in order for a person having ordinary skill in the art to which the present invention pertains to carry out the present invention. The present invention may be modified in various different ways, and is not limited to the disclosed embodiments herein. In order to clarify a description of the present invention, a description of parts not related to the description is omitted, and the same reference numbers are used throughout the specification to refer to the same or like parts.

Hereinafter, an embodiment of the present invention is described in detail with reference to the accompanying drawings.

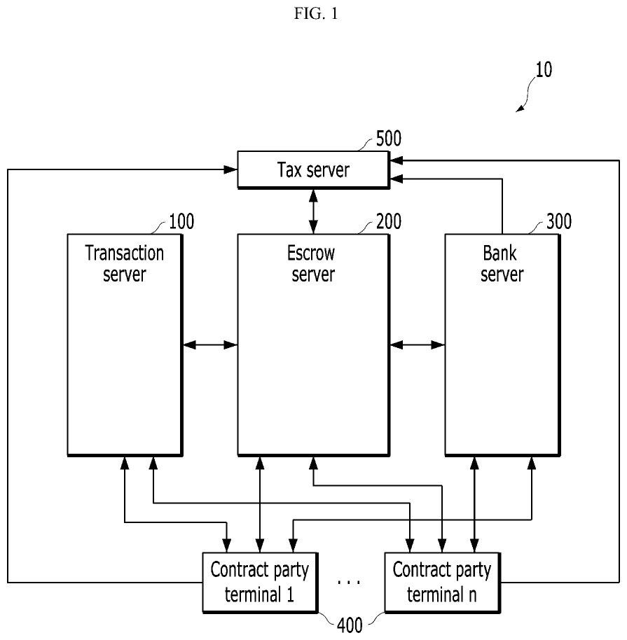

FIG. 1 shows a configuration of a system 10 for providing a real estate transaction service according to an embodiment of the present invention. The system 10 for providing a real estate transaction service according to the present invention includes a transaction server 100, an escrow server 200, a bank server 300, a contract party terminal 400 and a tax server 500.

The transaction server 100 functions to generate trading contract information between contract parties and to transmit the trading contract information to the escrow server 200. When a buyer and a seller determines a transaction price, a contract amount, a purchase payment condition (a down payment, a middle payment, the remainder, etc.), a special agreement, the payment date, etc. through the contract party terminal 400, the transaction server 100 generates trading contract information, including an item address, a transaction price, a contract amount, a purchase payment condition, a special agreement, a contract date, a middle payment date, a remainder date, personal information (a name, a social security number, a contact number, and an address) of the buyer, and personal information of the seller, and transmits the trading contract information to the escrow server 200.

Furthermore, when a judicial scrivener, etc. notifies the transaction server 100 that a real estate-related report procedure has been completed, the transaction server 100 generates a real estate-related report procedure completion signal and transmits it to the escrow server 200. In this case, the real estate-related report procedure may be an ownership transfer registration procedure in the case of a real estate sales contract, and may be an application for a fixed date or a procedure for a moving-in report application in the case of a real estate lease contract. In the case of the real estate sales contract, the judicial server (not shown) may transmit, to the transaction server 100, a message providing notification that the ownership transfer registration has been applied. In the case of the real estate lease contract, the judicial server (not shown) may transmit, to the transaction server 100, a message providing notification that a lessee has applied a fixed date or a moving-in report through the contract party terminal 400.

The transaction server 100 according to the present invention may be configured with a plurality of the transaction servers 100. The escrow server 200 may receive trading contract information from the plurality of transaction servers 100. Furthermore, the transaction server 100 according to an embodiment of the present invention may be divided into an intermediary server and a judicial server. In this case, the intermediary server functions to generate trading contract information between contract parties and to transmit the trading contract information to the escrow server 200. The judicial server functions to perform a real estate-related report procedure and to transmit a report procedure completion signal to the escrow server 200. The system 10 for providing a real estate transaction service according to an embodiment of the present invention includes a judicial scrivener terminal. The judicial scrivener may access the escrow server 200 through the judicial scrivener terminal, and may transmit a real estate-related report procedure completion signal.

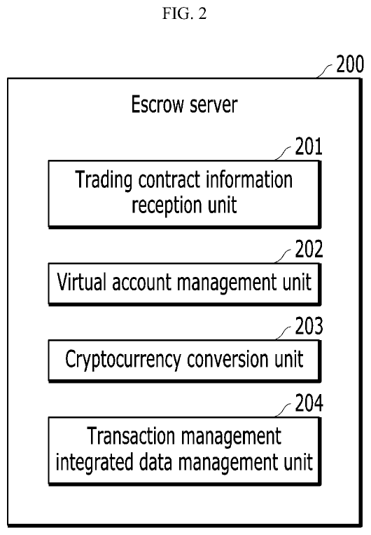

The escrow server 200 is an element to perform a method of providing a real estate transaction service according to an embodiment of the present invention. The escrow server 200 is described with reference to FIG. 2.

FIG. 2 is a diagram for describing elements within the escrow server 200 according to an embodiment of the present invention. The escrow server 200 according to the present invention includes a trading contract information reception unit 201, a virtual account management unit 202, a cryptocurrency conversion unit 203, and a transaction management integrated data management unit 204.

The trading contract information reception unit 201 is an element to receive trading contract information from the transaction server 100. In the present invention, the trading contract information may include an item address, a transaction price, a contract amount, a purchase payment condition, a special agreement, a contract date, a middle payment date, a remainder date, personal information (a name, a social security number, a contact number, and an address) of a buyer, personal information of a seller, etc.

The virtual account management unit 202 is an element to confirm a virtual account registered with the bank server 300 while operating in conjunction with the bank server 300. When the buyer of a trading contract deposits a transaction price into a designated virtual account, the bank server 300 notifies the virtual account management unit 202 of the fact of the deposit. The virtual account management unit 202 confirms an amount deposited into the virtual account through the bank server 300. The virtual account management unit 202 according to an embodiment of the present invention may confirm whether a buyer has deposited an accurate transaction price by confirming a virtual account registered with the bank server 300 in a preset cycle.

The cryptocurrency conversion unit 203 is an element to convert, into cryptocurrency, a transaction price deposited into a virtual account by a buyer. In the present invention, the cryptocurrency is numerical data indicative of a transaction price managed in the escrow server 200. Actual cash deposited by the buyer is written in the virtual account registered with the bank server 300. Transactions are performed in the escrow server 200 in cryptocurrency. In the present invention, upon conversion into cryptocurrency, the cryptocurrency conversion unit 203 may convert actual cash at a ratio of 100:1 to 1,000,000:1, etc. In general, a real estate transaction price is performed in a ten billion or hundred billion unit. Accordingly, upon conversion into cryptocurrency, management can be facilitated because order of magnitude is decreased. Furthermore, an actual transaction price can be prevented from being exposed because cash is converted into cryptocurrency by decreasing order of magnitude at a given ratio.

The cryptocurrency conversion unit 203 according to an embodiment of the present invention may perform encryption when conversing an actual transaction price into cryptocurrency. The cryptocurrency conversion unit 203 may perform decryption when transmitting an order instructing an amount corresponding to cryptocurrency to be paid in cash when transmitting the order to the bank server 300. In this case, security can be improved because an actual transaction price is prevented from being exposed.

The transaction management integrated data management unit 204 is an element to generally manage the deposit and payment of cryptocurrency within the escrow server 200. The transaction management integrated data management unit 204 confirms the authentication of the party concerned of a trading contract through a certificate, etc. and then generates transaction management integrated data. In the present invention, the transaction management integrated data may include a present situation table and trading contract information, including a down payment, a middle payment, a date for each remainder, a deposit amount, the amount of payment, a policy number and a payment place. The transaction management integrated data management unit 204 generates first transaction management integrated data after confirming the authentication of the party concerned of a first trading contract, and generates second transaction management integrated data after confirming the authentication of the party concerned of the first trading contract and the authentication of the party concerned of a second trading contract. In this case, it is advisable that the authentication of all the party concerned be confirmed for the safety of transactions, but the authentication of only some parties may be confirmed through another procedure for guaranteeing security, such as a preliminary declaration of intention, a separate agreement, a contract agreement, etc. of some parties. Furthermore, in the step of generating the second transaction management integrated data, the second transaction management integrated data may be generated without authenticating the first trading contract party not the second trading contract party. Furthermore, when the seller of the first trading contract requests cryptocurrency payment, the transaction management integrated data management unit 204 generally manages transaction management integrated data by updating the payment details of the first transaction management integrated data and the deposit details of the second transaction management integrated data.

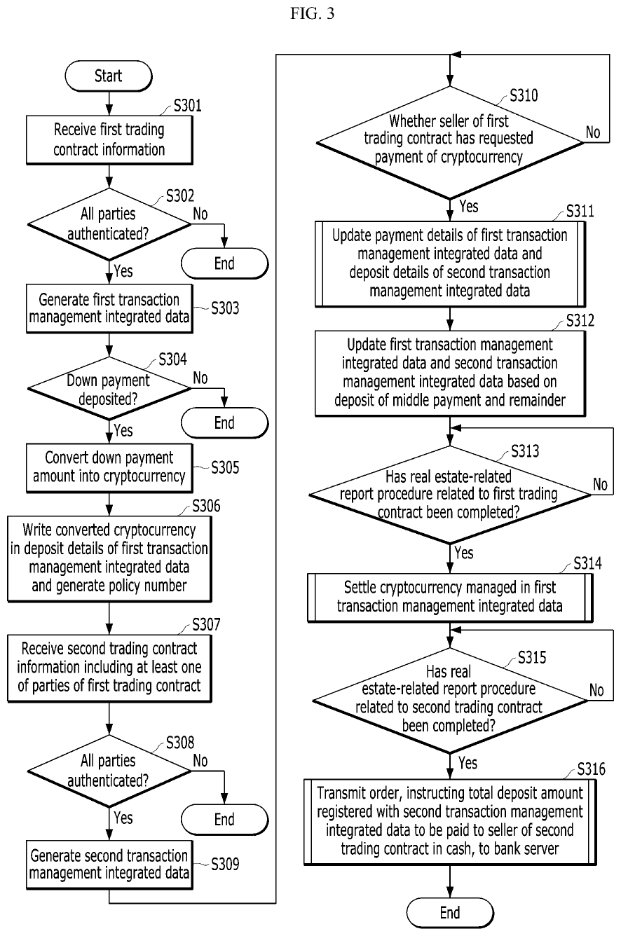

When receiving a real estate-related report (ownership transfer registration, an application for a fixed date or a moving-in report) procedure completion signal related to the first trading contract from the transaction server 100, the transaction management integrated data management unit 204 performs a procedure of settling cryptocurrency managed in the first transaction management integrated data and then terminates the management of the first transaction management integrated data. Furthermore, when receiving a real estate-related report procedure completion signal related to the second trading contract from the transaction server 100, the transaction management integrated data management unit 204 writes a purchase amount payment completion message in the second transaction management integrated data and transmits, to the bank server 300, an order instructing a total deposit amount registered with the second transaction management integrated data to be paid to the seller of the second trading contract in cash, thereby terminating the management of the second transaction management integrated data. The steps of the method of providing, by the escrow server 200, a real estate transaction service are described in detail with reference to FIG. 3.

The bank server 300 is an element to perform a role of generating and managing the virtual account of a real estate transaction party concerned. When receiving a virtual account generation request signal from the contract party terminal 400, the bank server 300 confirms personal information of the contract party and generates a virtual account. When receiving a virtual account confirmation request signal from the virtual account management unit 202 of the escrow server 200, the bank server 300 transmits virtual account information of a corresponding party concerned to the virtual account management unit 202. Furthermore, when the contract party concerned deposits a transaction price to the virtual account, the bank server 300 transmits, to the virtual account management unit 202, information on whether the transaction price has been deposited and a deposit amount. When a real estate-related report procedure, such as ownership transfer registration, is completed and a cash payment order is received from the escrow server 200, the bank server 300 deposits cash into a designated account.

The contract party terminal 400 is a terminal used by a real estate transaction contract party concerned, and may be configured in the form of a wired or wireless terminal. In the case of a real estate sales contract, a buyer and a seller may access the transaction server 100 using the contract party terminal 400 and determine real estate sales contract contents. The contract party terminal 400 has stored authentication information of a contract party, and may transmit the authentication information to the escrow server 200 in response to a request from the escrow server 200. Furthermore, the contract party terminal 400 transmits a cryptocurrency payment request signal to the escrow server 200 in response to the input of an order from the seller. In this case, the seller may select the amount of cryptocurrency payment and a payment date through the contract party terminal 400. In addition, the contract party terminal 400 may transmit, to the transaction server 100, a message providing notification that an application for a fixed date has been completed in response to a command from a user. Furthermore, the contract party terminal 400 may transmit a transfer tax or acquisition and registration tax report request signal to the tax server 500 in response to the input of a buyer or seller. In the present invention, the escrow server 200, together with the transaction server 100, may be configured as a single server. In this case, a licensed real estate agent may access the escrow server 200 through a licensed real estate terminal (not shown), and may transmit trading contract information. According to an embodiment of the present invention, a buyer and a seller may directly access the escrow server 200 using the contract party terminal 400, and may transmit real estate transaction contract information.

The tax server 500 is a server that performs business processing related to the tax of a seller and buyer after real estate sales transactions are completed. The tax server 500 receives transaction management integrated data from the escrow server 200 through communication with the escrow server 200. The tax server 500 writes a transfer tax return or an acquisition and registration tax return according to a previously registered form based on transaction management integrated data received from the escrow server 200. When certificate authentication is confirmed based on information received from the contract party terminal 400, the tax server 500 completes the writing of the transfer tax return or an acquisition and registration tax return. When the deposit of the tax into a virtual account registered with the bank server 300 is confirmed, the tax server 500 automatically generates an electronic tax payment receipt and transmits the electronic tax payment receipt to a related institution server, such as a National Tax Service server.

In the present invention, the transaction server 100, the escrow server 200, the bank server 300, the contract party terminal 400 and the tax server 500 may transmit and receive data through wired/wireless communication. The wireless communication may include code division multiple access (CDMA), wideband code division multiple access (WCDMA), global system for mobile communication (GSM), long term evolution (LTE), world interoperability for microwave access (WIMAX), a wireless local area network (wireless LAN), a wide area network (WAN), a near field communication (NFC) module, Bluetooth, a radio frequency identification (RFID), Zigbee, a ultra wideband (UWB), infrared data association (IrDA), magnetic secure transmission (MST), etc.

The detailed elements of the system 10 for providing a real estate transaction service and the escrow server 200 according to the present invention have been described above. A method of providing a real estate transaction service, which is performed in the escrow server 200, is described below.

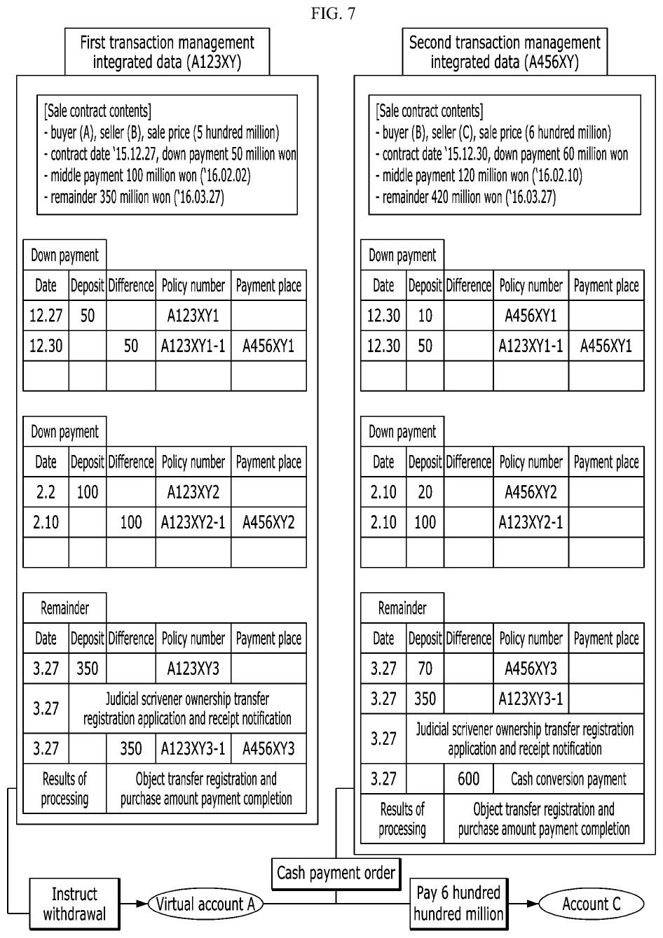

FIG. 3 is a flowchart illustrating a method of providing, by the escrow server 200, a real estate transaction service according to an embodiment of the present invention. FIG. 3 is described with reference to FIG. 7 showing an example of transaction management integrated data. In FIGS. 3 and 7, a method of providing a real estate transaction service, when two associated trading contracts (first trading contract and second trading contract) are performed, is described.

At step S301, the escrow server 200 receives first trading contract information from the transaction server 100. When a buyer and a seller determine a transaction price, a contract amount, a purchase payment condition (a down payment, a middle payment, the remainder, etc.), a special agreement, a payment date, etc. through the contract party terminal 400, the transaction server 100 generates trading contract information, including an item address, a transaction price, a contract amount, a purchase payment condition, a special agreement, a contract date, a middle payment date, a remainder date, personal information (a name, a social security number, a contact number, and an address) of the buyer, and personal information of the seller, and transmits the trading contract information to the escrow server 200. Meanwhile, if the real estate transaction is a rental such as a lease, when a lessee and a lessor determine earnest money, a transaction price, a contract amount, a purchase payment condition (a down payment, a middle payment, the remainder, etc.), a special agreement, a payment date, etc. through the contract party terminal 400, the transaction server 100 generates trading contract information, including an item address, the transaction price, the contract amount, the purchase payment condition, the special agreement, a contract date, a middle payment date, a remainder date, personal information (a name, a social security number, a contact number, and an address) of the lessor, and personal information of the lessee, and transmits the trading contract information to the escrow server 200. In the entire contents of the description of the present invention, a real estate sales contract is basically described, but the present invention is identically applied to a lease contract. In this case, a seller and a buyer may be changed into a lessor and a lessee and applied, and a sale price may be changed into earnest money or key money, etc. and applied.

At step S302, the escrow server 200 determines whether all of the parties of the first trading contract, that is, the seller and the buyer, perform authentication. The seller and the buyer may perform certificate authentication through the contract party terminal 400. The escrow server 200 confirms whether both parties have been authenticated. At step S302, if any one of the parties does not perform certificate authentication, the process is terminated. At step S302, the authentication may include various forms of authentication procedures, such as an operation of inputting a confirmation button or OK button displayed on the contract party terminal 400, an operation of recognizing a fingerprint in the case of a terminal supporting fingerprint recognition, and an operation of entering a password, in addition to certificate authentication.

If it is determined that all of the parties have performed authentication, at step S303, the escrow server 200 generates first transaction management integrated data. In the present invention, the transaction management integrated data may include a present situation table and trading contract information, including a down payment, a middle payment, a date for each remainder, a deposit amount, the amount of payment, a policy number and a payment place. In this case, the escrow server 200 may generate a management number while generating transaction management integrated data. In the present invention, the management number may be configured with an item address and the social security number of a party concerned. FIG. 7 is an example of the transaction management integrated data, and shows the present situation table configured with the management number (A123XY) of the first transaction management integrated data, sales contract contents (buyer information (A), seller information (B), sale price (5 hundred million), contract date (Dec. 27, 2015), down payment (50 million won), middle payment (100 million won), middle payment date (Feb. 2, 2016), remainder (350 million won), remainder date (Mar. 27, 2016)), a down payment, a middle payment, a date for each remainder, a deposit amount, the amount of payment, a policy number and a payment place.

If the escrow server 200 determines that the down payment has been deposited by the buyer A of the first trading contract at step S304, the escrow server 200 converts the down payment amount into cryptocurrency at step S305. If the bank server 300 determines that the down payment has been deposited into a virtual account registered with the personal information of the buyer of the first trading contract, the bank server 300 notifies the escrow server 200 of the deposit of the down payment. The escrow server 200 recognizes that the down payment has been deposited by the buyer of the first trading contract. Thereafter, the escrow server 200 converts the down payment into cryptocurrency by changing order of magnitude at a given ratio. For example, if the down payment is 50 million won, the escrow server 200 may convert the down payment into cryptocurrency 50 at a ratio of 1,000,000:1.

At step S306, the escrow server 200 writes the converted cryptocurrency in the deposit details of the first transaction management integrated data and generates a policy number. The escrow server 200 writes the deposit date and deposit amount in the present situation table of the first transaction management integrated data, generates a policy number derived from the management number of the first transaction management integrated data, and writes the generated policy number in the present situation table. In the present invention, the escrow server 200 may generate the policy number in a form in which identifier signs indicative of a down payment, a middle payment, and the remainder are added to the management number. For example, in the case of the down payment, a policy number may be generated as a management number+1, a middle payment may be generated as a management number+2, and the remainder may be generated as a management number+3. FIG. 7 shows a form in which a deposit date (December 27), a down payment amount (50), and a policy number (A123XY1) have been written in the down payment present situation table. In this case, the policy number has been generated as a management number (A123XY)+1.

At step S307, the escrow server 200 receives, from the transaction server 100, second trading contract information including at least one of the parties of the first trading contract. If the seller B of the first trading contract is to obtain another real property, the seller B makes a second trading contract with a third party C through the transaction server 100. The transaction server 100 transmits, to the escrow server 200, second trading contract information with the buyer B and the seller C.

At step S308, the escrow server 200 determines whether all of the parties of the first trading contract and the second trading contract perform authentication. That is, the escrow server 200 determines whether all of the buyer A of the first trading contract, B who is the seller of the first trading contract and is the buyer of the second trading contract, and the seller C of the second trading contract perform authentication. If any one does not perform authentication at step S308, the process is terminated.

If it is determined that all of the parties concerned have performed the authentication, at step S309, the escrow server 200 generates second transaction management integrated data. The escrow server 200 generates the second transaction management integrated data and simultaneously generates a management number. FIG. 7 shows a present situation table configured with the management number (A456XY) of the second transaction management integrated data, sales contract contents (buyer information (B), seller information (C), sale price (6 hundred million), contract date (Dec. 30, 2015), down payment (60 million won), middle payment (120 million won), middle payment date (Feb. 10, 2016), remainder (420 million won), remainder date (Mar. 27, 2016)), a down payment, a middle payment, a date for each remainder, a deposit amount, the amount of payment, a policy number and a payment place.

At step S310, the escrow server 200 determines whether the payment of the cryptocurrency is requested by the seller of the first trading contract. If the seller B of the first trading contract wants to use the down payment, deposited into the virtual account of the buyer A of the first trading contract, as the down payment of the second trading contract, the seller B transmits a cryptocurrency payment request signal to the escrow server 200 using the contract party terminal 400.

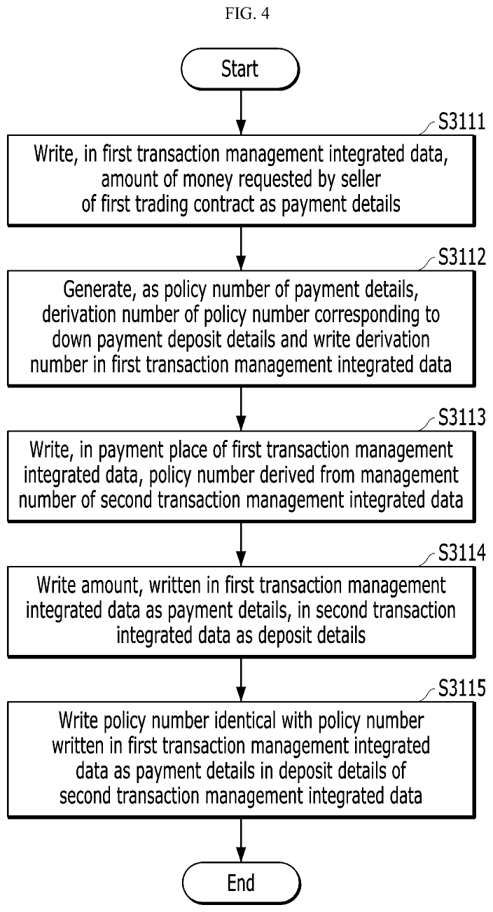

At step S311, the escrow server 200 that has received the cryptocurrency payment request signal updates the payment details of the first transaction management integrated data and the deposit details of the second transaction management integrated data. When an event to request the payment of cryptocurrency from a contract party concerned occurs or when an event in which a contract party concerned deposits a transaction price into a virtual account occurs, the escrow server 200 writes and updates deposit details and payment details for the first transaction management integrated data and the second transaction management integrated data. Detailed steps of step S311 are described in detail with reference to FIG. 4.

FIG. 4 is a flowchart illustrating detailed steps of step S311 in FIG. 3. At step S3111, the escrow server 200 writes, in the first transaction management integrated data, the amount of money requested by the seller of the first trading contract as the payment details. Furthermore, the escrow server 200 generates, as the policy number of the payment details, a derivation number of the policy number corresponding to the down payment deposit details and writes the derivation number in the first transaction management integrated data at step S3112, and writes, in the payment place of the first transaction management integrated data, a policy number derived from the management number of the second transaction management integrated data at step S3113. At step S3112, the derivation number may correspond to a policy number in which a derivation sign, such as −1 or /1, has been added to the original policy number. For example, if a policy number corresponding to deposit details is A123XY1, a derivation number may be A123XY1-1.

At step S3113, the escrow server 200 confirms another contract (second trading contract) including the party of the first trading contract, and confirms the management number of the second transaction management integrated data. Furthermore, after confirming the property of the price requested to be paid by the seller of the first trading contract, the escrow server 200 writes, in the payment place of the first transaction management integrated data, a policy number derived from the management number of the second transaction management integrated data. For example, if the management number of the second transaction management integrated data is A456XY and the property of the price is a down payment, the policy number may be written in the payment place of the first transaction management integrated data as A456XY1. FIG. 7 shows a form in which a payment date (December 30), payment details (50), a policy number (A123XY1-1) and a payment place (A456XY1) have been written in the down payment present situation table of the first transaction management integrated data.

At step S3114, the escrow server 200 writes an amount, written in the first transaction management integrated data as the payment details, in the second transaction integrated data as the deposit details. At step S3115, the escrow server 200 writes the same policy number as the policy number, written in the first transaction management integrated data as the payment details, in the deposit details of the second transaction management integrated data. The step S3115 is to represent the source of cryptocurrency. For example, if a policy number written as the payment details of the first transaction management integrated data is A123XY1-1, the same A123XY1-1 is written as the policy number of the deposit details of the second transaction management integrated data.

FIG. 7 shows a form in which a deposit date (December 30), deposit details (50), and a policy number (A123XY1-1) have been written in the down payment present situation table of the second transaction management integrated data.

After step S311 is terminated, at step S312, the escrow server 200 updates the first transaction management integrated data and second transaction management integrated data based on the deposit of the middle payment and the remainder. When the buyer of the first trading contract and the buyer of the second trading contract deposit the middle payment and the remainder into the virtual account registered with the bank server 300, the escrow server 200 writes a deposit date, deposit details, and a policy number in the middle payment present situation table and remainder present situation table of the first transaction management integrated data and the second transaction management integrated data. Furthermore, when the seller of the first trading contract requests the payment of cryptocurrency for the middle payment, the escrow server 200 writes a payment date, payment details, a policy number and a payment place in the middle payment present situation table of the first transaction management integrated data, and writes a deposit date, deposit details, and a policy number in the middle payment present situation table of the second transaction management integrated data.

FIG. 7 shows a form in which the deposit date (February 2), the deposit details (100), and the policy number (A123XY2) have been written in the middle payment present situation table of the first transaction management integrated data and a deposit date (March 27), deposit details (350), and a policy number (A123XY3) have been written in the remainder present situation table of the first transaction management integrated data based on the deposit of the middle payment and remainder of the buyer of the first trading contract. Furthermore, FIG. 7 shows a form in which a deposit date (February 10), deposit details (20), and a policy number (A456XY2) have been written in the middle payment present situation table of the second transaction management integrated data and a deposit date (70), deposit details (70), and a policy number (A456XY3) have been written in the remainder present situation table of the second transaction management integrated data based on the deposit of the middle payment and remainder of the buyer of the second trading contract. Furthermore, FIG. 7 shows a form in which a payment date (February 10), payment details (100), a policy number (A123XY2-1), and a payment place (A456XY2) have been written in the middle payment present situation table of the first transaction management integrated data and a deposit date (February 10), deposit details (100), and a policy number (A123XY2-1) have been written in the middle payment present situation table of the second transaction management integrated data based on a request for the payment of cryptocurrency by the seller of the first trading contract.

After updating the first transaction management integrated data and the second transaction management integrated data based on the deposit of the middle payment and the remainder, at step S313, the escrow server 200 confirms whether a real estate-related report procedure related to the first trading contract has been completed. When a judicial scrivener, etc. notifies the transaction server 100 that the real estate-related report procedure has been completed, the transaction server 100 generates a real estate-related report procedure completion signal and transmits it to the escrow server 200. The escrow server 200 may confirm whether the real estate-related report procedure has been completed. In the present invention, the real estate-related report procedure may be an ownership transfer registration procedure in the case of a real estate sales contract, and may be an application for a fixed date or a procedure for a moving-in report application in the case of a real estate lease contract.

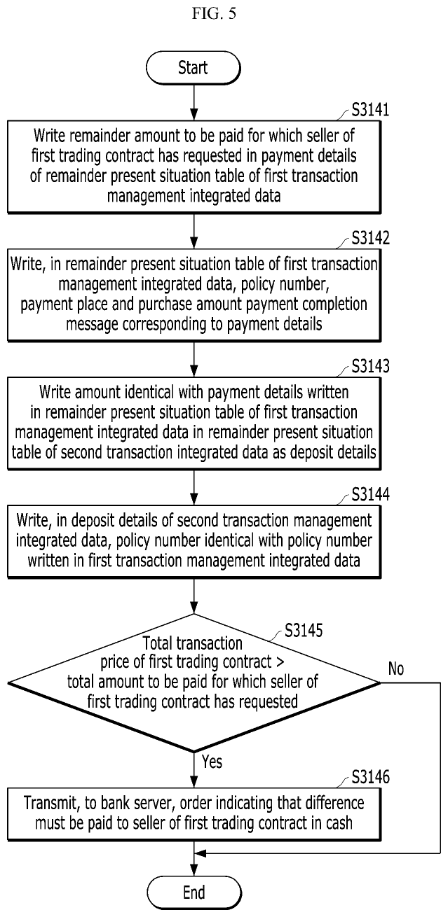

When confirming that the real estate-related report procedure has been completed, the escrow server 200 performs a procedure of settling cryptocurrency managed in the first transaction management integrated data at step S314. Detailed steps of step S314 are described in detail with reference to FIG. 5.

FIG. 5 is a flowchart illustrating detailed steps of step S314 in FIG. 3. At step S3141, the escrow server 200 writes, in the payment details of the remainder present situation table of the first transaction management integrated data, the remainder amount to be paid for which the seller of the first trading contract has requested. Furthermore, at step S3142, the escrow server 200 writes, in the payment details of the remainder present situation table of the first transaction management integrated data, a policy number, payment place and purchase amount payment completion message corresponding to the payment details. In this case, the escrow server 200 generates the derivation number of the policy number, corresponding to the remainder deposit details, as the policy number of the remainder payment details, writes the generated derivation number in the remainder present situation table of the first transaction management integrated data, and writes, in the payment place of the remainder present situation table of the first transaction management integrated data, a policy number derived from the management number of the second transaction management integrated data. FIG. 7 shows a form in which a payment date (March 27), payment details (350), a policy number (A123XY3-1) and a payment place (A456XY) have been written in the remainder present situation table of the first transaction management integrated data. Furthermore, FIG. 7 also shows a real estate-related report procedure completion message (judicial scrivener ownership transfer registration application and receipt notification) and a purchase amount payment completion message (object transfer registration and purchase amount payment completion).

At step S3143, the escrow server 200 writes, as the deposit details of the remainder present situation table of the second transaction integrated data, the same amount as an amount written as the payment details in the remainder present situation table of the first transaction management integrated data. At step S3144, the escrow server 200 identically writes, in the deposit details of the second transaction management integrated data, the same policy number as the policy number written in the first transaction management integrated data as the payment details. FIG. 7 shows a form in which a deposit date (March 27), deposit details (350), and a policy number (A123XY3-1) have been written in the remainder present situation table of the second transaction management integrated data.

At step S3145, the escrow server 200 compares the total transaction price of the first trading contract and a total amount to be paid for which the seller of the first trading contract has requested. If it is determined that the total transaction price of the first trading contract is greater than the total amount that has been requested, at step S3146, the escrow server 200 transmits, to the bank server, an order instructing a difference (the total transaction price of the first trading contract>the total amount to be paid for which the seller of the first trading contract has requested) to be paid to the seller of the first trading contract in cash. A case where the seller of the first trading contract requires only some of an amount deposited by the buyer of the first trading contract without requiring the entire amount while performing the second trading contract may occur. In this case, the escrow server 200 pays the remaining amount to the seller of the first trading contract in cash except an amount requested by the seller of the first trading contract among the total amount (the total transaction price of the first trading contract) deposited by the buyer of the first trading contract. Through such a procedure, the escrow server 200 finishes a process of settling cryptocurrency managed in the first transaction management integrated data.

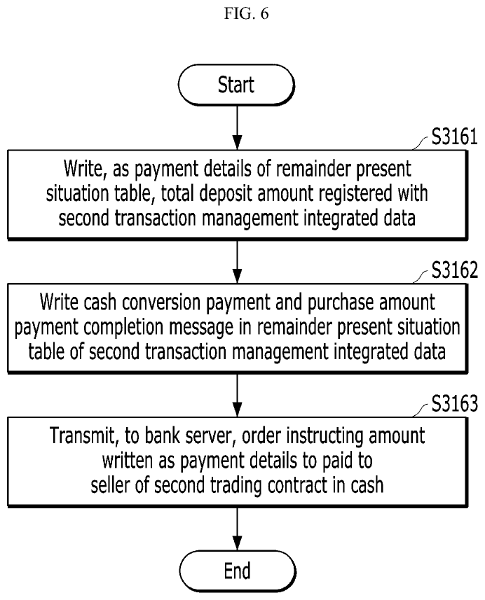

At step S315, the escrow server 200 confirms whether the real estate-related report procedure related to the second trading contract has been completed. If it is confirmed that the real estate-related report procedure related to the second trading contract has been completed, at step S316, the escrow server 200 transmits, to the bank server, an order instructing the total deposit amount registered with the second transaction management integrated data to be paid to the seller of the second trading contract in cash. Detailed steps of step 5316 are described in detail with reference to FIG. 6.

FIG. 6 is a flowchart illustrating detailed steps of step S316 in FIG. 3. At step S3161, the escrow server 200 writes, as the payment details of the remainder present situation table, the total deposit amount registered with the second transaction management integrated data. Cryptocurrency directly deposited by the seller of the second trading contract and cryptocurrency requested to be paid in the first transaction management integrated data are written in the down payment, middle payment, and remainder present situation tables. The escrow server 200 sums a total deposit amount registered so far, and writes the sum deposit amount as the payment details of the remainder present situation table.

The escrow server 200 writes cash conversion payment and a purchase amount payment completion message in the remainder present situation table of the second transaction management integrated data at step S3162, and transmits, to the bank server, an order instructing an amount written as the payment details to be paid to the seller of the second trading contract in cash at step S3163. FIG. 7 shows a payment date (March 27), payment details (600), a cash conversion payment message, a real estate-related report procedure completion message (judicial scrivener ownership transfer registration application and receipt notification) and a purchase amount payment completion message (object transfer registration and purchase amount payment completion) together in the remainder present situation table of the second transaction management integrated data.

The amount deposited into the virtual account by the buyer A of the first trading contract can be directly deposited into the account of the seller C of the second trading contract in cash when the second trading contract is completed. Accordingly, although the escrow method is used, the seller B of the first trading contract can use the amount deposited by the buyer A of the first trading contract while performing the real estate transaction of the second trading contract.

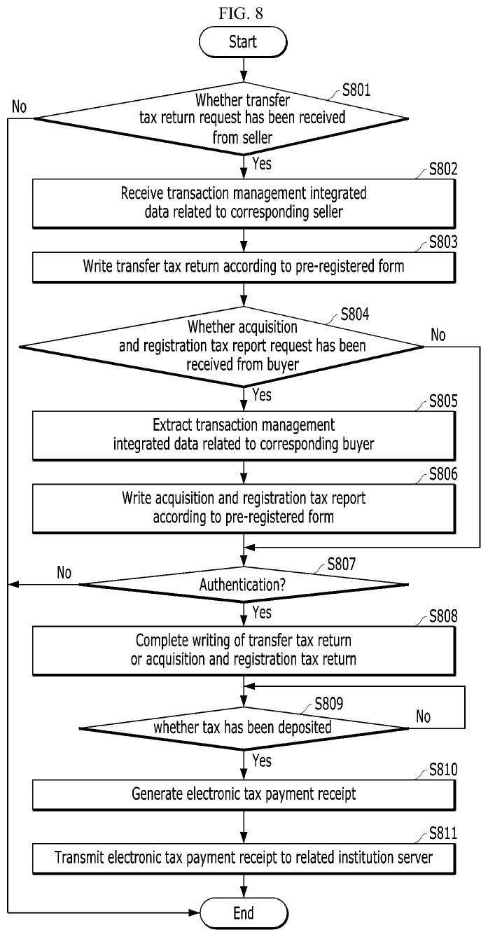

FIG. 8 is a flowchart illustrating a process of processing, by the tax server 500, tax-related business after real estate transactions are completed according to an embodiment of the present invention.

At step S801, the tax server 500 determines whether a transfer tax return request is received from a seller. The seller may request the transfer tax return through the transaction party terminal 400. The tax server 500 receives the transfer tax return request of the seller through the transaction party terminal 400.

If it is determined that the transfer tax return request of the seller has been received, at step S802, the tax server 500 receives transaction management integrated data related to the corresponding seller through the escrow server 200. The tax server 500 may request, from the escrow server 200, the transaction management integrated data related to the corresponding seller, and may receive the transaction management integrated data through the escrow server 200. The transaction management integrated data includes trading contract information, information on whether a real estate-related report procedure has been completed, information on whether the payment of a transaction price has been completed, etc. At step S803, the tax server 500 writes a transfer tax return according to a pre-registered form based on the received transaction management integrated data.

At step S804, the tax server 500 determines whether an acquisition and registration tax report request is received from a buyer. If it is determined that the acquisition and registration tax report request is received, at step S805, the tax server 500 receives transaction management integrated data related to the corresponding buyer through the escrow server 200. Next, at step S806, the tax server 500 writes a transfer tax return according to a pre-registered form based on the received transaction management integrated data.

At step S807, the tax server 500 determines whether the buyer or the seller has performed authentication through the transaction party terminal 400. If it is determined that the buyer or the seller has performed authentication, at step S808, the tax server 500 completes the writing of the transfer tax return or the acquisition and registration tax return. The tax server 500 performs communication with the bank server 300. At step S809, the tax server 500 determines whether a tax is deposited by the seller or the buyer through the bank server 300. The buyer or the seller may deposit the tax into a virtual account registered with the bank server 300. The tax server 500 can confirm whether the buyer or the seller has deposited the tax by confirming the virtual account.

If it is determined that the tax has been deposited, the tax server 500 generates an electronic tax payment receipt at step S810, and transmits an electronic tax payment receipt to a related institution server at step S811. In this case, the related institution corresponds to a public institute related to a tax, such as a National Tax Service. Accordingly, the seller and the buyer can automatically process a tax payment and return although they do not directly visit a bank or do not perform Internet banking.

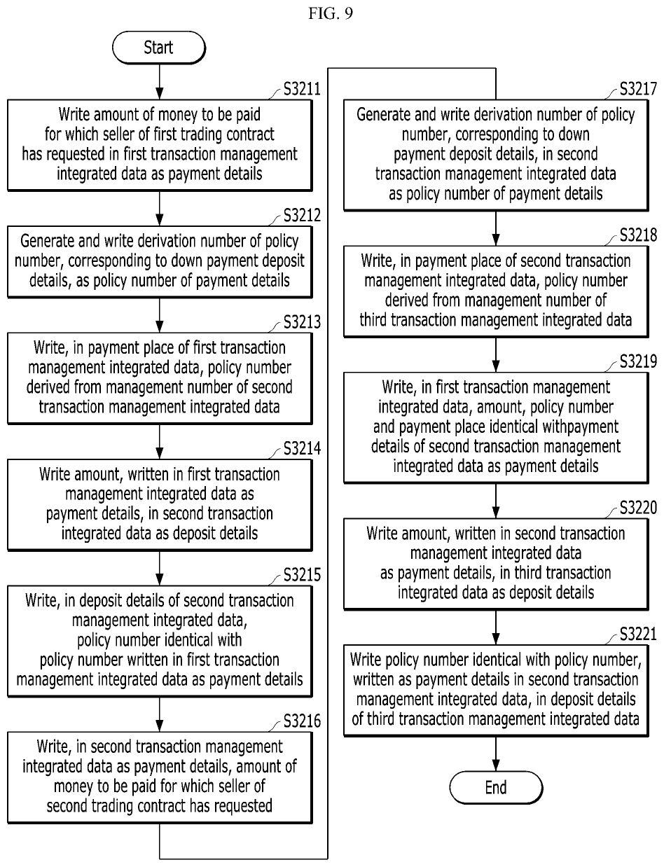

FIG. 9 is a flowchart for describing a process of updating, by the escrow server 200, first transaction management integrated data to third transaction management integrated data when three associated real estate transaction contracts are performed in the method of providing a real estate transaction service according to an embodiment of the present invention. FIG. 9 is described with reference to FIG. showing an example of transaction management integrated data.

FIG. 9 is a flowchart materializing step S311 of FIG. 3. It is assumed that prior to step S311, first transaction management integrated data, second transaction management integrated data and third transaction management integrated data have been generated and the seller of a first trading contract and the seller of a second trading contract have requested the payment of cryptocurrency.

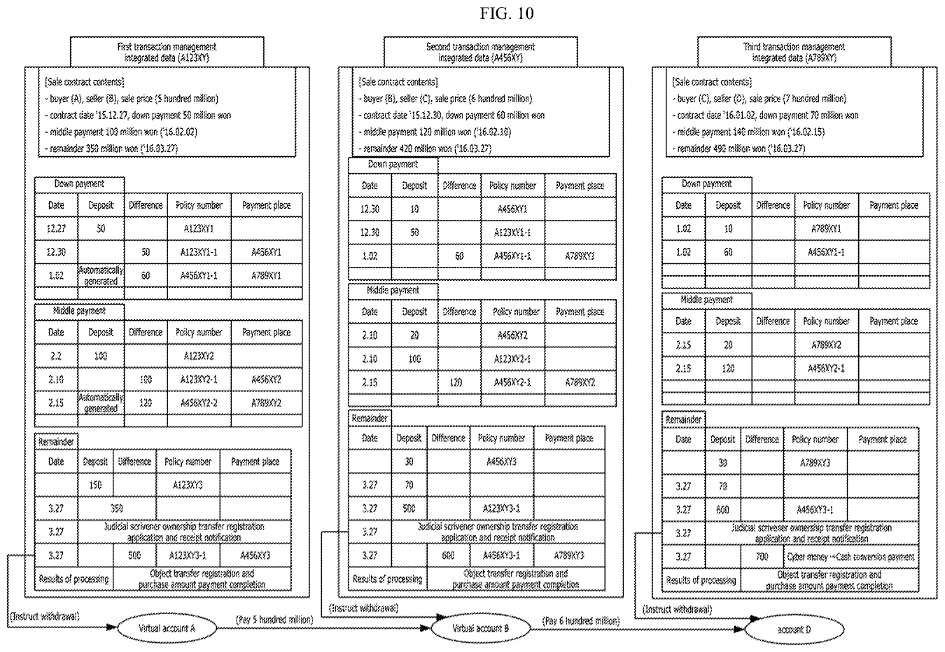

At step S3211, the escrow server 200 writes the amount of money to be paid for which the seller of the first trading contract has requested in the first transaction management integrated data as payment details. The escrow server 200 generates the derivation number of a policy number, corresponding to down payment deposit details, as the policy number of the payment details at step S3212, writes the generated derivation number in the first transaction management integrated data, and writes, in the payment place of the first transaction management integrated data, a policy number derived from the management number of the second transaction management integrated data at step S3213. At step S3213, the escrow server 200 confirms another contract (the second trading contract) including the party of the first trading contract and confirms the management number of the second transaction management integrated data. Furthermore, after confirming the property of a price to be paid for which the seller of the first trading contract has requested, the escrow server 200 writes, in the payment place, a policy number derived from the management number of the second transaction management integrated data. FIG. 10 shows a form in which a payment date (December 30), payment details (50), a policy number (A123XY1-1) and a payment place (A456XY1) have been written in the down payment present situation table of the first transaction management integrated data.

At step S3214, the escrow server 200 writes an amount, written in the first transaction management integrated data as the payment details, in the second transaction integrated data as the deposit details. At step S3215, the escrow server 200 writes, in the deposit details of the second transaction management integrated data, the same policy number as the policy number written in the first transaction management integrated data as the payment details. The step is to indicate the source of cryptocurrency. FIG. 10 shows a form in which a deposit date (December 30), deposit details (50), and a policy number (A123XY1-1) have been written in the down payment present situation table of the second transaction management integrated data.

At step S3216, the escrow server 200 writes, in the second transaction management integrated data as payment details, the amount of money to be paid for which the seller of the second trading contract has requested. At step S3217, the escrow server 200 generates the derivation number of a policy number, corresponding to the down payment deposit details, as the policy number of the payment details, and writes the generated derivation number in the second transaction management integrated data. At step S3218, the escrow server 200 writes, in the payment place of the second transaction management integrated data, a policy number derived from the management number of the third transaction management integrated data. At step S3218, the escrow server 200 confirms another contract (the third trading contract) including the party of the second trading contract, and confirms the management number of the third transaction management integrated data. Furthermore, after confirming the property of a price to be paid for which the seller of the second trading contract has requested, the escrow server 200 writes, in the payment place, a policy number derived from the management number of the third transaction management integrated data. FIG. 10 shows a form in which a payment date (January 2), payment details (60), a policy number (A456XY1-1) and a payment place (A789XY1) have been written in the down payment present situation table of the second transaction management integrated data.

At step S3219, the escrow server 200 writes, in the first transaction management integrated data, the same amount, policy number and payment place as the payment details of the second transaction management integrated data as payment details. The escrow server 200 generally manages the first to third transaction management integrated data and the first to third trading contracts are associated. Accordingly, if the seller B of the first trading contract uses the deposit amount of the first trading contract in the second trading contract and the seller C of the second trading contract uses the deposit amount of the second trading contract in the third trading contract, an amount deposited by the buyer A of the first trading contract can be directly transmitted to the seller D of the third trading contract. Accordingly, when the seller of the second trading contract requests the payment of cryptocurrency, the escrow server 200 also writes, in the first transaction management integrated data, the same amount, policy number and payment place as the payment details of the second transaction management integrated data. FIG. 10 shows a form in which a payment date (January 2), payment details (60), a policy number (A456XY1-1) and a payment place (A789XY1) have been written in the down payment present situation table of the first transaction management integrated data as in the second transaction management integrated data.

At step S3220, the escrow server 200 writes the amount, written in the second transaction management integrated data as the payment details, in the third transaction integrated data as deposit details. At step S3221, the escrow server 200 identically writes, in the deposit details of the third transaction management integrated data, the same policy number as the policy number written in the second transaction management integrated data as the payment details. The step is to indicate the source of cryptocurrency. FIG. 10 shows a form in which a deposit date (January 2), deposit details (60), and a policy number (A456XY1-1) have been written in down payment present situation table of the third transaction management integrated data.

The method of updating transaction management integrated data, described with reference to FIG. 9, may be identically applied to the middle payment and remainder in S312 of FIG. 3.

According to the present invention, when a seller performs a plurality of real estate transaction contracts for purchasing another real property while selling his or her real property, real estate transactions can be performed more safely because the contracts are integrated and managed in the escrow server. Furthermore, when simultaneously performing a contract for purchasing another real property, a real property seller can reduce a burden of the payment of a price because the seller can use a down payment and middle payment deposited by a buyer. Even in the case of a real estate lease, although a lessor borrows another real property while renting his or her real property, the lessor can use a down payment and middle payment deposited by the lessee.

The aforementioned embodiments may be implemented as a hardware component, a software component and/or a combination of them. For example, the apparatus and components described in the embodiments may be implemented using one or more general-purpose computers or special-purpose computers, for example, a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processing apparatus may perform an operating system (OS) and one or more software applications executed on the OS. Furthermore, the processing apparatus may access, store, manipulate, process and generate data in response to the execution of software. For convenience of understanding, one processing apparatus has been illustrated as being used, but a person having ordinary skill in the art may understand that the processing apparatus may include a plurality of processing elements and/or a plurality of types of processing elements. For example, the processing apparatus may include a plurality of processors or a single processor and a single controller. Furthermore, other processing configurations, such as a parallel processor, are also possible. Software may include a computer program, code, an instruction or a combination of one or more of them and may configure a processor so that it operates as desired or may instruct the processor independently or collectively. The software and/or data may be (permanently or temporarily) embodied in a machine, component, physical device, virtual equipment or computer storage medium or device of any type (or a transmitted signal wave) in order to be interpreted by the processor or to provide an instruction or data to the processor. The software may be distributed to computer systems connected over a network and may be stored or executed in a distributed manner. The software and data may be stored in one or more computer-readable recording media.

The method according to an embodiment may be implemented in the form of program instructions that can be executed by a variety of computer means, and may be stored in a computer-readable storage medium. The computer-readable storage medium may include program instructions, a data file, and a data structure alone or in combination. The program instructions that are stored in the medium may be specially designed and constructed for the embodiment, or may be known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices specially configured to store and execute program instructions such as ROM, RAM, and flash memory. Examples of the program instructions include not only machine language code that is constructed by a compiler but also high-level language code that can be executed by a computer using an interpreter or the like. The aforementioned hardware components may be configured to act as one or more software modules that perform the operation of the present invention, and vice versa.

As described above, although the embodiments have been described in connection with the limited embodiments and drawings, those skilled in the art may modify and change the embodiments in various ways from the description. For example, proper results may be achieved although the above descriptions are performed in order different from that of the described method and/or the aforementioned elements, such as the system, configuration, device, and circuit, are coupled or combined in a form different from that of the described method or replaced or substituted with other elements or equivalents. Accordingly, other implementations, other embodiments, and equivalents of the claims belong to the scope of the claims.

### Mode for Invention

A form for an implementation of the invention has been described in the best form for implementing the invention.

### INDUSTRIAL APPLICABILITY

The present invention relates to the method and system for providing a real estate transaction service, and may be applied to a method and system for providing various types of real estate transaction services and has an industrial applicability because it has a repetition possibility.

1. A method of providing, by an escrow server, a real estate transaction service in a real estate transaction service system comprising the escrow server, a bank server and a transaction server, the method comprising:
a step of confirming authentication of parties of a first trading contract when first trading contract information is received from the transaction server and then generating first transaction management integrated data;
a step of converting, into cryptocurrency, a transaction price deposited by a buyer of the first trading contract;
a step of confirming authentication of parties of a second trading contract when second trading contract information comprising at least one of the parties of the first trading contract is received from the transaction server and then generating second transaction management integrated data;
a step of updating payment details of the first transaction management integrated data and deposit details of the second transaction management integrated data when a seller of the first trading contract makes a cryptocurrency payment request; and
a final payment step of transmitting, to the bank server, an order instructing a total deposit amount registered with the second transaction management integrated data to be paid to a seller of the second trading contract in cash when real estate-related report procedure completion signals related to the first trading contract and the second trading contract are received from the transaction server.

2. The method of claim 1, wherein each of the first and second trading contract information comprises at least one of an item address, a sales amount, a lease guarantee amount, a contract amount, a payment condition, a contract date, a middle payment date, a remainder date, buyer information, seller information, lessor information, and lessee information.

3. The method of claim 2, wherein each of the first and second transaction management integrated data comprises a present situation table and trading contract information comprising a down payment, a middle payment, a date for each remainder, a deposit amount, the amount of payment, a policy number and a payment place.

4. The method of claim 1, wherein the step of converting the transaction price into the cryptocurrency further comprises a step of writing the converted cryptocurrency in the deposit details of the first transaction management integrated data and generating a policy number.

5. The method of claim 1, wherein the step of generating the second transaction management integrated data comprises confirming the authentication of the parties of the first trading contract and the second trading contract when the second trading contract information is received and then generating the second transaction management integrated data.

6. The method of claim 4, wherein the step of updating comprises steps of:
writing the amount of money requested to be paid in the first transaction management integrated data as the payment details when the seller of the first trading contract makes the cryptocurrency payment request;
generating a derivation number of the generated policy number as a policy number of the payment details and writing the generated derivation number in the first transaction management integrated data;
writing a policy number of the second transaction management integrated data in a payment place of the first transaction management integrated data;
writing an amount written in the payment details of the first transaction management integrated data as the deposit details of the second transaction management integrated data; and
identically writing, in the deposit details of the second transaction management integrated data, a policy number identical with the policy number written as the payment details in the first transaction management integrated data.

7. The method of claim 6, wherein the final payment step comprises steps of:
settling the cryptocurrency managed in the first transaction management integrated data when the real estate-related report procedure completion signal related to the first trading contract is received from the transaction server; and
transmitting, to the bank server, an order instructing the total deposit amount registered with the second transaction management integrated data to be paid to the seller of the second trading contract in cash when the real estate-related report procedure completion signal related to the second trading contract is received from the transaction server.

8. The method of claim 7, wherein the settling step comprises steps of:
writing, in the payment details of the first transaction management integrated data, the amount of money to be paid for which the seller of the first trading contract has requested when the real estate-related report procedure completion signal related to the first trading contract is received from the transaction server;
writing, in the first transaction management integrated data, a policy number, a payment place and a purchase amount payment completion message corresponding to the payment details;
writing an amount identical with the amount, written in the first transaction management integrated data as the payment details, in the second transaction management integrated data as the deposit details; and
identically writing, in the deposit details of the second transaction management integrated data, a policy number identical with the policy number written in the first transaction management integrated data.

9. The method of claim 8, further comprising steps of:
comparing a total amount to be paid for which the seller of the first trading contract has requested with a total transaction price of the first trading contract; and
transmitting, to the bank server, an order instructing a difference to be paid to the seller of the first trading contract when the total transaction price of the first trading contract is greater than the total amount requested to be paid.

10. The method of claim 7, wherein the step of transmitting the order to the bank server comprises steps of:
writing, as the payment details, a total deposit amount registered with the second transaction management integrated data when the real estate-related report procedure completion signal related to the second trading contract is received from the transaction server;
writing a purchase amount payment completion message in the second transaction management integrated data; and
transmitting, to the bank server, an order instructing the amount written as the payment details to be paid to the seller of the second trading contract in cash.

11. The method of claim 1, further comprising steps of:
confirming authentication of the parties of the first trading contract, the second trading contract and a third trading contract when third trading contract information comprising at least one of the parties of the first trading contract and the second trading contract is received from the transaction server and then generating third transaction management integrated data;
updating the payment details of the first transaction management integrated data, the deposit details and payment details of the second transaction management integrated data, and deposit details of the third transaction management integrated data when the seller of the first trading contract makes the cryptocurrency payment request; and
transmitting, to the bank server, an order instructing a total deposit amount registered with the third transaction management integrated data
to be paid to a seller of the third trading contract in cash when real estate-related report procedure completion signals related to the first trading contract, the second trading contract and the third trading contract are received from the transaction server.

12. A system for providing a real estate transaction service, comprising:
a transaction server generating trading contract information and a real estate-related report procedure completion signal related to a trading contract;
an escrow server confirming authentication of parties of the first trading contract when first trading contract information is received from the transaction server and then generating first transaction management integrated data, converting, into cryptocurrency, a transaction price deposited by a buyer of the first trading contract, confirming authentication of parties of the first trading contract and the second trading contract when second trading contract information comprising at least one of the parties of the first trading contract is received and then generating second transaction management integrated data, updating payment details of the first transaction management integrated data and deposit details of the second transaction management integrated data when a seller of the first trading contract makes a cryptocurrency payment request, and transmitting, to a bank server, an order instructing a total deposit amount registered with the second transaction management integrated data to be paid to a seller of the second trading contract when real estate-related report procedure completion signals related to the first trading contract and the second trading contract are received from the transaction server; and
the bank server executing the payment of the cash to an agreed account registered with the seller of the second trading contract when the cash payment order is received from the escrow server.

13. An escrow server comprising:
a trading contract information reception unit receiving, from a transaction server, first trading contract information and second trading contract information comprising at least one of parties of a first trading contract;
a virtual account management unit confirming whether a transaction price has been deposited by a buyer of the first trading contract or a buyer of a second trading contract;
a cryptocurrency conversion unit converting, into cryptocurrency, the transaction price deposited by the buyer of the first trading contract or the buyer of the second trading contract; and
a transaction management integrated data management unit generating first transaction management integrated data after confirming authentication of parties of the first trading contract, generating second transaction management integrated data after confirming authentication of parties of the first trading contract and the second trading contract, updating payment details of the first transaction management integrated data and deposit details of the second transaction management integrated data when a seller of the first trading contract makes a cryptocurrency payment request, and transmitting, to a bank server, an order instructing a total deposit amount registered with the second transaction management integrated data to be paid to a seller of the second trading contract in cash when real estate-related report procedure completion signals related to the first trading contract and the second trading contract are received from the transaction server.
